(19) United States
(12) Patent Application Publication
(10) Pub. No.: US 2007/0285814 A1
(43) Pub. Date: Dec. 13, 2007

(54) RECORDING DEVICE

(75) Inventor: Stephen Grant, Toorak (AU)

Correspondence Address: KNOBBE MARTENS OLSON & BEAR LLP, 2040 MAIN STREET, FOURTEENTH FLOOR, IRVINE, CA, 92614, US

(73) Assignee: Maclaw No. 477 Pty Ltd, South Melbourne (AU)

(21) Appl. No.: 11/750,933

(22) Filed: May 18, 2007

(30) Foreign Application Priority Data
May 19, 2006 (AU) 2006902712

(51) Int. Cl. G11B 25/00

(52) U.S. Cl. 360/1

(57) ABSTRACT

A recording device for recording and playback of audio data has a body which is relatively thin for incorporation between the pages of an album or within the cover of an album is disclosed. Recording and playback controls are accessible from the front face of the body and are physically shielded to prevent inadvertent actuation when the album is closed. At least one replaceable battery is accessible via a removable battery cover provided on the front face.

### BACKGROUND OF THE INVENTION

The present invention relates to a recording device for use in an album for storing photographs and the like, a journal, a scrapbook or similar products comprising interleaved sheets usually between front and rear covers. For convenience, these will be referred to hereinafter simply as “albums”.

### SUMMARY OF CERTAIN INVENTIVE ASPECTS

One aspect of the present invention provides a recording device including i) a body which is relatively thin for incorporation between the pages of an album or within the cover of an album, ii) a storage for recording and playback of audio data, and iii) recording and playback control means accessible from the front face of the body and shielded to prevent inadvertent actuation when the album is closed.

In one embodiment, recording and playback control means are accessible from the front face of the body and are physically shielded to prevent inadvertent actuation when the album is closed. Such shielding can be simply achieved by recessing the control means, for example control buttons, beneath the front face.

In one embodiment, a microphone and a speaker for recording and playback are associated with apertures on the front face.

In one embodiment, the device has at least one replaceable battery accessible via a removable battery cover provided on the front face. In that case the storage is non-volatile, for example in the form of a flash memory chip.

For application to a page of the album, a rear face of the body of the storage device may be provided with an adhesive coating, for example protected by a layer which is removed prior to application.

In one embodiment, the device is approximately the same size as a credit card, but of somewhat greater thickness, but no more than about 5 mm.

Another aspect of the invention provides a recording device and a spacer. The recording device includes i) a body of no more than approximately 5 mm in thickness for incorporation between the pages of an album, ii) an adhesive on the rear face of the body for attachment to a page of the album, iii) a storage for recording and playback of audio data, iv) a microphone and speaker for recording and playback associated with apertures in the front face of the body, and v) at least one replaceable battery accessible via a removeable battery cover on the front face. The spacer has a thickness corresponding to that of a recording device, wherein the spacer is in the form of a strip applicable to the page adjacent the spine of the album to extend lengthwise of the page, the spacer being apertured to receive page fastenings extending between front and rear covers of the album so that it is retained by those fastenings.

### BRIEF DESCRIPTION OF THE DRAWINGS

Embodiments of the invention will now be described by way of example only with reference to the accompanying drawings.

FIG. 1 is a front view of a recording device in accordance with one embodiment of the invention.

FIG. 2 is an end view.

FIG. 3 shows an actuating probe for recording.

FIG. 4 shows a plug for disabling the record function.

FIG. 5 shows separate parts for forming a spacer strip.

FIGS. 6 and 7 show how the parts are connected together to suit different album sizes.

FIG. 8 shows a template for forming a decorative cover for the recording device.

### DESCRIPTION OF CERTAIN INVENTIVE EMBODIMENTS

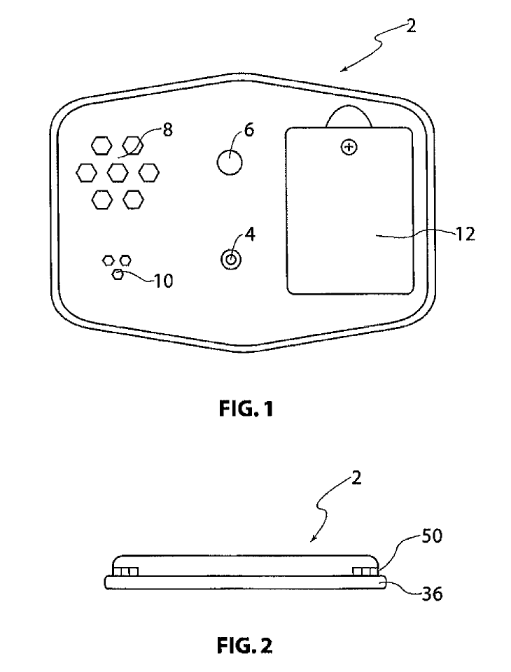

A recording device 2 in accordance with one embodiment of the invention is of relatively thin construction, no more than approximately 5 mm in thickness so that it can be applied to a page of an album without unduly increasing the bulk of the album. It is also of a size approximately equivalent to that of a standard credit card. The recording device is intended to record voice and other data relevant to matter stored within the album. For example a child may record a short message relating to some photographs of that child stored within the album. The basic technology of the recording device is well known and understood by those skilled in the art and a detailed description is not necessary. Briefly, however the device will include a non-volatile recordable storage, for example a flash memory chip, a microphone for recording, a speaker for playback, and record and play buttons. All of these components face onto the front face of the body of the device. In FIG. 1 the record and play buttons are designated 4, 6 respectively and apertures associated with the speaker and microphone are designated 8, 10 respectively. A battery compartment, closeable by a removable cover 12, is also accessible from the front face.

In one embodiment, the recording device 2 is attached to a sheet of the album by adhesive applied to the rear face of the body and the device is supplied with an adhesive coating already applied to its rear face and protected by a peelable layer.

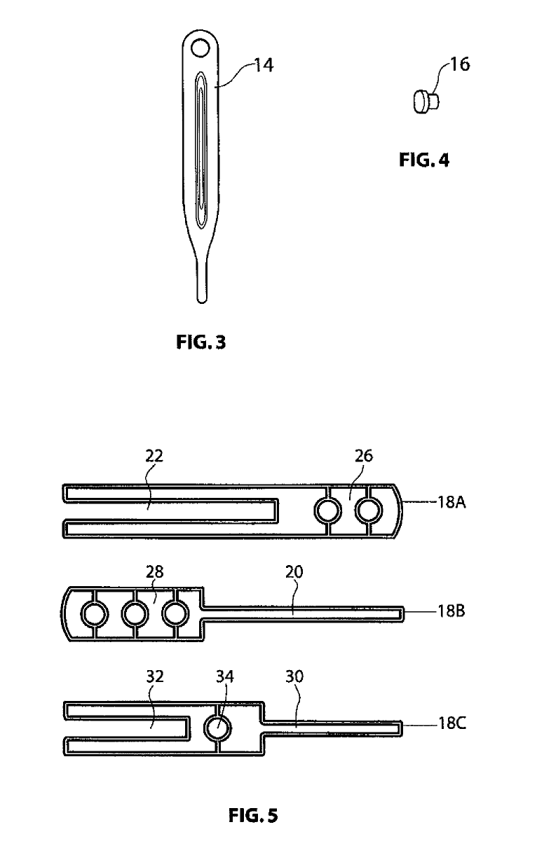

As the recording device will be lying between the pages of the album it is important to ensure that the record and play buttons cannot be inadvertently actuated when the album is closed and for this purpose the controls are shielded against inadvertent actuation. In the embodiment shown this is simply achieved by recessing the buttons beneath the front face of the body. The record button 4 is more deeply recessed than the play button 6 and is accessible via a small opening using a small diameter probe 14 (FIG. 3) or the pointed end of a pencil, to minimise the risk of recording over a previous recording except as a deliberate action. A plug 16 (FIG. 4) is also provided for insertion into the small opening in order to block access to the record button 4 and thereby to disable the record function.

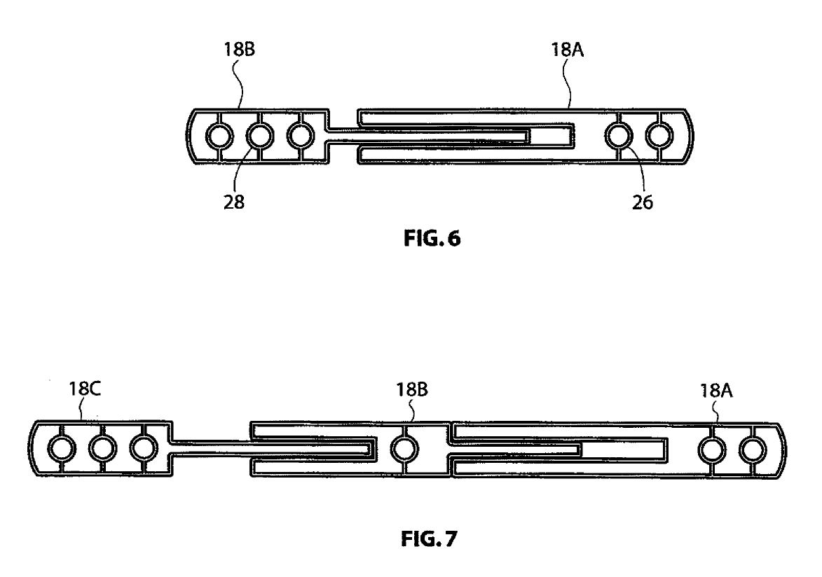

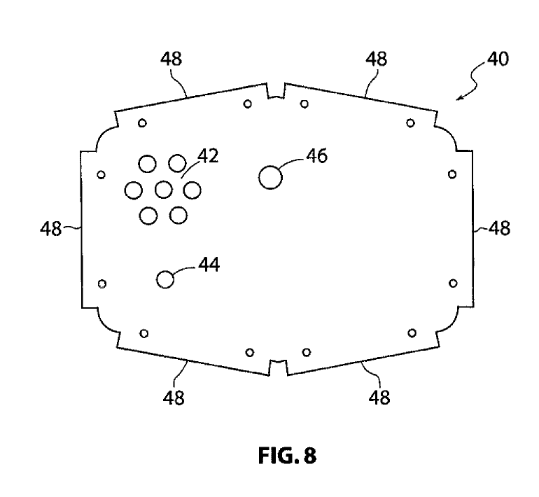

Albums of the type with which the device will be used are usually of variable thickness so as to accommodate photographs and other matter inserted into the album and usually with provision for insertion or removal of individual pages. This is usually achieved by means of an adjustable and releaseable page fastening system extending between the front and rear covers. In order to better ensure that the album will close “flat” even with the recording device fixed between the pages of the album, in one embodiment, it is to install between the page on which the album is fixed and the adjacent page a spacer of a thickness corresponding to that of the recording device. The spacer is of strip form applied to the page adjacent the spine of the album, with the spacer strip extending along the length of the page at the spine and being apertured to receive the page fastenings extending between the front and rear covers so that it is also retained by the fastenings. Such a spacer strip can be inexpensively formed from plastics foam such as polystyrene foam, or as an injection moulding in plastics. In one embodiment, the recording device will be supplied together with the spacer strip and for convenience of packaging the spacer strip can be supplied as two or more component parts which are coupled together prior to use. FIG. 5 shows spacer strip component parts 18A, 18B, 18C which are slidably and adjustably interconnected in different combinations to suit a range of different albums. For 15 cm×15 cm (6″×6″) albums or 20 cm×20 cm (8″×8″) albums, parts 18A and 18B are connected as shown in FIG. 6 with spigot 20 of 18B engaged in slot 22 of 18A, the two parts being slidably adjusted so that a respective one of their apertures 26, 28 will align with an adjacent hole in the page. For larger albums, 30 cm×30 cm (12″×12″) the three parts are used as shown in FIG. 7 with spigot 30 of part 18C engaged in slot 22 of part 18A and spigot 20 of part 18B engaged in slot 32 of part 18C. The respective parts are again adjusted to suit the hole spacing and the intermediate part 18C itself has an aperture for use with a three-hole fastening.

In the form thus far described, the recording device and spacer strip (if provided) are supplied for application to an album by the customer. In an alternative, an album can be supplied with the recording device already installed within one of the covers. For this purpose the body of the recording device is of stepped cross-section to provide a peripheral rim 36 (see FIG. 2) so that the recording device can be fitted between two layers of the cover with the front face of the device lying within a cut-out in one of the layers so as to lie flush with that layer and with the rim 36 providing at the rear of the body a lip to retain the body within the aperture.

The stepped cross-section of the body is also of benefit in enabling a user to apply a decorative cover of paper or similar to the front of the recording device. FIG. 8 shows a template 40 for cutting out a paper cover. The template provides apertures 42, 44, 46 corresponding to the positions of the speaker, microphone and the play button. It also provides extension flaps 48 which in the cut-out are folded over the outer edge of the body of the recording device. At each corner portion of the outer edge adjacent the peripheral rim 36, the edge is formed with a recess 50 (also seen in FIG. 2) to receive and retain an elastic band which is applied around the folded flaps to retain the cover in place. The cover can then be further decorated as desired.

In a practical embodiment, the recording device is provided in a package together with the probe 14 (FIG. 3), the plug 16 (FIG. 4), the component parts 18A, 18B, 18C of the spacer strip (FIG. 5) and the template 40 (FIG. 7) together with an elastic band of appropriate size for retention of the decorative cover.

While the above description has pointed out the novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A recording device, comprising:
a body configured to be incorporated between the pages of an album or within the cover of an album;
a storage configured to record and playback of audio data; and
a recording and playback controller being accessible from the front face of the body and shielded to prevent inadvertent actuation when the album is closed.

2. A recording device, comprising:
a body configured to be incorporated between the pages of an album or within the cover of an album;
a non-volatile storage configured to record and playback of audio data;
a recording and playback controller being accessible from the front face of the body and shielded to prevent inadvertent actuation when the album is closed;
a microphone and a speaker configured to record and playback associated with apertures on the front face of the body, respectively; and
at least one replaceable battery accessible via a removable battery cover provided on the front face.

3. A recording device according to claim 2, wherein the controller is recessed within the front face, and wherein the recording device further comprises a plug optionally insertable into the recess to prevent over-recording.

4. A recording device according to claim 2, wherein the body has a stepped outer rim to provide at the rear of the body a lip for retention of the body within an aperture in a cover of an album.

5. An apparatus, comprising:
a recording device comprising i) a body of no more than approximately 5 mm in thickness for incorporation between the pages of an album, ii) an adhesive on the rear face of the body for attachment to a page of the album, iii) a storage configured to record and playback of audio data, iv) a microphone and speaker configured to record and playback associated with apertures in the front face of the body, respectively, and v) at least one replaceable battery accessible via a removeable battery cover on the front face; and
a spacer having a thickness corresponding to that of a recording device, wherein the spacer is in the form of a strip applicable to the page adjacent the spine of the album to extend lengthwise of the page, and wherein the spacer is apertured to receive page fastenings extending between front and rear covers of the album so that it is retained by those fastenings.

6. An apparatus according to claim 5, wherein the spacer comprises two or more parts interconnectable to provide a spacer strip of a variable length which is adjustable to suit different sizes of album.

7. An apparatus according to claim 6, further comprising:
a controller configured to perform record function within a recess in the front face of the body; and
a plug optionally insertable into the recess of the controller and configured to disable the controller so as to prevent over-recording.

8. An apparatus according to claim 7, further comprising:
a template configured to cut a decorative cover of paper to be applied to the front face of the body, wherein the template is further configured to provide apertures corresponding to microphone and speaker apertures in the front face of the body and flaps extending over a peripheral edge of the body for co-operation with an elastic band applied around the periphery of the body to retain the decorative cover thereto.

9. A recording device, comprising:
a body which is configured to be incorporated between the pages of an album or within the cover of an album;
means for recording and playbacking audio data; and
recording and playback controls being accessible from the front face of the body and shielded to prevent inadvertent actuation when the album is closed.
